(19) United States
(12) Patent Application Publication
(10) Pub. No.: US 2007/0163828 A1
(43) Pub. Date: Jul. 19, 2007

(54) Flywheel drive system for a motor vehicle and method therefor

(76) Inventor: Carl Manganaro, Mesa, AZ (US)

Correspondence Address: WEISS & MOY PC, 4204 NORTH BROWN AVENUE, SCOTTSDALE, AZ, 85251, US

(21) Appl. No.: 11/331,633

(22) Filed: Jan. 13, 2006

(51) Int. Cl. B60K 1/00

(52) U.S. Cl. 180/165; 180/65.1

(57) ABSTRACT

An apparatus for generating an electric current to drive a vehicle has an electric motor coupled to each rear wheel of the vehicle. The electric motors are used to drive each rear wheel. A main generator is coupled to each electric motor. The main generator powers each electric motor. A flywheel is coupled to the main generator. The flywheel powers the main generator. A starter device is coupled to the flywheel. The starter device causes the flywheel to begin to rotate.

### BACKGROUND OF INVENTION

1. Field of Invention

The present invention relates to a drive system for a motor vehicles and more specifically, to a flywheel design system that powers an electric motor for propelling a motor vehicle.

2. Description of Related Art

In order to reduce the dependence on fossil fuels, alternative methods to drive motor vehicles need to be developed. One of the explored technologies is the use of electric motors in automobiles. Electric motors generally are powered by a DC power source such as a battery and do not require the use of gasoline or diesel fuel. One benefit of using electric motors is that they do not emit pollutants into the atmosphere since they do not burn fossil fuels. Electric motors provide a clean source of power to propel a motor vehicle.

One requirement of electric motors is the need for a large energy storage system to provide continuous power. One solution has been to use car batteries to power the electric motors. However, batteries have to be continuously recharged in order to fully power the electric vehicle. Car batteries also only have a limited number of times in which they may be recharged. Once a car battery can no longer be recharged, it must be disposed. Many people feel that disposing of the used car batteries may be a larger environmental problem than burning fossil fuels.

One solution to using batteries to power electric motors has been to use a flywheel. As compared to batteries, which have a limited number of charges before replacement, a flywheel will have an almost unlimited lifespan with proper maintenance, despite a large number of charge and discharge cycles. Furthermore, flywheels have a fast recharge time as compared to batteries. A large battery may take several hours to recharge, while a flywheel may take minutes. In addition, the flywheel is a clean source of power for the electric motor. As power is transferred to the motor, the flywheel also emits no pollutants, thereby, limiting harmful emissions into the atmosphere. Thus, a motor vehicle driven by a flywheel drive system containing electric motors provides a substantial benefit over drive systems using combustion engines.

While present flywheel systems for driving electric powered vehicles do currently work, they have several problems. First, most electric vehicles are limited as to the speed the vehicle may travel. Most electric vehicles are driven by a single electric motor. The power provided by a single electric motor is generally limited due to the weight of the vehicle. Furthermore, a single electric motor fails to provide sufficient power to satisfy most consumers. Most electric vehicles have a fairly slow acceleration rate when the driver presses on the gas pedal. Second, most flywheels are generally started by use of a battery. However, if the battery should fail, most flywheel systems have no back-up power supply to start the flywheel.

Therefore, a need existed to provide a system and method to overcome the above problem.

### SUMMARY OF INVENTION

An objective of the invention is to provide electricity to drive a vehicle. In the present invention, a flywheel is coupled with a main generator, and the flywheel's rotation powers the main generator. In addition, the main generator is coupled with electric motors connected to the rear wheels of the vehicle through an electrical connection. These electric motors drive the rotation of each of the rear wheels with current provided by the main generator. Furthermore, a starter device starts the rotation of the flywheel, which in the present invention but not limited to a battery or an A/C outlet.

To further enhance the capability of the present invention, in addition to the main generator, secondary generators are attached to the two front wheels, which provide additional current to the main generator when the vehicle is in motion, thus, saving the stored energy in the flywheel. Furthermore, the starter device causes the flywheel to rotate at a maximum speed, which allows the flywheel to reach maximum charge.

### BRIEF DESCRIPTION OF DRAWINGS

FIG. 1 is a simplified block diagram of the flywheel drive system of the present invention.

FIG. 2 is a top view of the flywheel drive system of the present invention.

FIG. 3 is a side view of the flywheel drive system of the present invention.

### DETAILED DESCRIPTION

The present invention is a flywheel system that drives a motor vehicle. In one embodiment of the invention, the flywheel is a source of power for a main generator, which in turn powers electric motors placed at each rear wheel of the vehicle. The electric motors cause the rear wheels to rotate and drive the motion of the vehicle. Furthermore, generators placed at each front wheel provide additional current to the main generator when the vehicle is in motion, thus saving the energy stored within the flywheel.

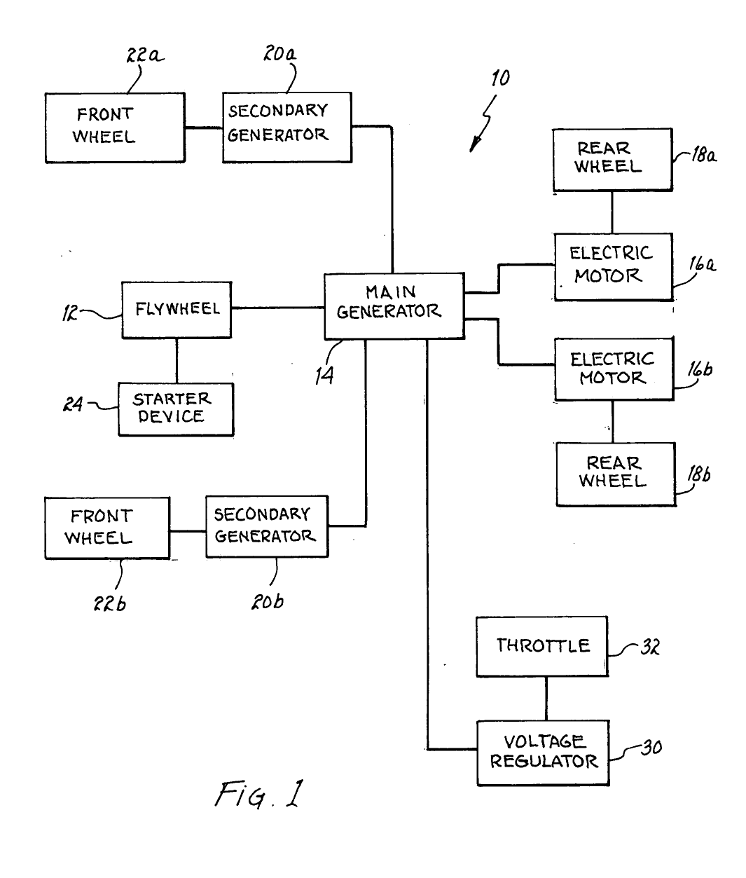

FIG. 1 illustrates a block diagram of the flywheel drive system of the present invention 10 (hereinafter system 10). Included in the invention is a flywheel 12 that stores energy used by the system through constant rotation. As stated before, a flywheel 12 is a clean energy source without emissions that can be charged and re-charged numerous times. In the present invention, the flywheel 12 is made of high tensile spring wire or other filament and is placed within a vacuum enclosure to increase efficiency. Furthermore, the flywheel 12 rotates a maximum speed to provide a constant energy source for the system 10.

A main generator 14 is electrically coupled to the flywheel 12. The flywheel 12 powers the main generator 14. The generator 14 is used to power two electric motors 16a and 16b. Each electric motor 16a and 16b are coupled to a corresponding rear wheel 18a and 18b of the vehicle. Prior flywheel drive systems use only a single electric motor that powers the drive train of a vehicle. In the present invention, the use of electric motors 16a and 16b at each rear wheel 18a and 18b applies rotational power at each wheel, thus creating a more efficient and powerful system. When current is supplied, the motors 16a and 16b drive the vehicle by rotating the rear wheels 18a and 18b resepctively. As the flywheel does not emit any emissions, the electric motors 16a and 16b also do not emit any emissions, thus contributing to the cleanliness of the motor vehicle drive system 10. In addition, since the electric motors 16a and 16b are not powered by gasoline or diesel like a combustion engine, the reliance on fossil fuels is reduced.

To achieve a desired speed, voltage regulators 30 controlled by a throttle manage 32 the current from the main generator 14 to the electric motors 16a and 16b. The level of current will either cause the vehicle to increase, decrease or maintain a constant speed. During this time, the flywheel 12 continues to rotate and provides constant energy to the system 10.

Also shown in FIG. 1, the system 10 includes secondary generators 20a and 20b. One of the secondary generators 20a and 20b is coupled to each of the front wheels 22a and 22b. Each of the generators 20a and 20b connects to the main generator 14 that powers the electric motors 16a and 16b at each of the rear wheels 18a and 18b. As the vehicle is in motion, the front wheels 22a and 22b rotate. The rotation of the front wheels 22a and 22b spin the generators 20a and 20b located at each of the wheels 22a and 22b. Thus while spinning, each generator 20a and 20b supplies electric current to the main generator 14, and thereby reducing the amount of energy used from the flywheel 12. As a result, the energy stored within the flywheel 12 is conserved for later use allowing the vehicle to travel longer distances between charges.

In order for the flywheel 12 to spin initially, a starter device 24 is connected with the flywheel 12 as shown in FIG. 1. The starter device 24 starts the flywheel 12 spinning until it reaches maximum speed and thus reaching a full charge. At this time, the system 10 is operational. In the one embodiment of the present invention, the starter device 24 is a battery 26 (FIG. 2), which is used only to start the flywheel 12 rotation and not used otherwise. In an alternative embodiment, the starter device 24 could be an A/C outlet 28 (FIG. 2), in which, the system 10 is plugged into a charging device or an electrical outlet. Either method provides the initial power needed to start the system 10.

FIG. 2 is a top view of the present invention showing the placement of the flywheel 12 of the present invention. Because of the constant rotation, the flywheel 12 must be placed in a location that will not deter the movement of the vehicle during acceleration, deceleration or maintaining a constant speed. Also shown in FIG. 2 is the main generator 14 connected to the flywheel 12. The main generator 14 can be placed at a convenient location within the vehicle in order to provide current to the electric motors 16a and 16b located at each of the rear wheels 18a and 18b, and to receive additional current from the secondary generators 20a and 20b located at the front wheels 22a and 22b of the vehicle. Furthermore, the placement of the main generator 14 must not interfere with the operation of the motor vehicle.

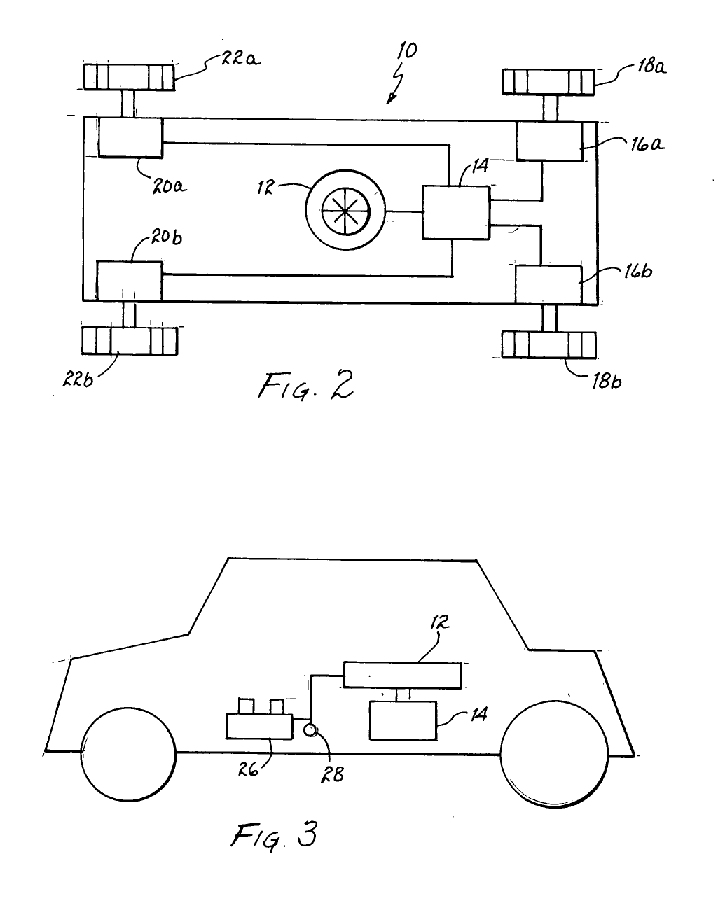

FIG. 3 is a side view of the present invention illustrating the possible starter devices of the flywheel drive system 10. Both the flywheel 12 and the main generator 14 are shown. Connected to the flywheel 12 is a battery 26. As stated before, the battery 26 starts the initial rotation of the flywheel 12 until it reaches maximum speed. Alternatively, an A/C outlet 28 can also start the rotation of the flywheel 12. Through the A/C outlet 28, the motor vehicle could be connected to a charging station or an electrical outlet of one's home to charge the flywheel 12. Both of these methods could be implemented in the flywheel drive system allowing the vehicle operator may options to start his vehicle.

Therefore, while the present invention has been shown and described herein in what is believed to be the most practical and preferred embodiments, it is recognized that departures can be made therefrom within the scope of the invention, which is not to be limited to the details disclosed herein but is to be accorded to the full scope of the claims so as to embrace any and all equivalent apparatus and processes.

I claim:

1. An apparatus for generating an electric current to drive a vehicle comprising:
an electric motor coupled to each rear wheel of the vehicle to drive each rear wheel;
a main generator coupled to each electric motor, the main generator powering each electric motor;
a flywheel coupled to the main generator, the flywheel powering the main generator; and
a starter device coupled to the flywheel, the starter device causes the flywheel to begin to rotate.

2. The apparatus of claim 1 further comprising a secondary generator coupled to each front wheel and to the main generator, the secondary generator provides additional current to the main generator.

3. The apparatus in claim 1, wherein the starter device is a battery.

4. The apparatus in claim 1, wherein the starter device is an A/C outlet.

5. The apparatus of claim 1, wherein the starter device causes the flywheel to rotate at a maximum speed.

6. The apparatus of claim 1, wherein the flywheel comprises a high tensile spring in a vacuum enclosure.

7. A method for generating an electrical current to drive a vehicle comprising:
starting the rotation of a flywheel coupled to a main generator;
powering electric motors coupled to each rear wheel of the vehicle with a main generator coupled to the flywheel; and
driving the real wheels of the vehicle with the powered electric motors.

8. A method of claim 7 wherein the starting of the rotation of the flywheel is carried out by a battery.

9. A method of claim 7 wherein the starting of the rotation of the flywheel is carried out by an A/C outlet.

10. A method of claim 7 wherein the flywheel is rotated to maximum speed.

11. A method of claim 7 wherein the main generator provides additional current to a secondary generator coupled to each front wheel.

12. A method of claim 7 wherein the flywheel comprises a high tensile spring in a vacuum enclosure.
